(19) United States
(12) Patent Application Publication
(10) Pub. No.: US 2007/0173230 A1
(43) Pub. Date: Jul. 26, 2007

(54) Wireless communication unit and a method of operation thereof

(76) Inventor: Peter William Hilding-Svendsen, Copenhagen (DK)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/580,146

(22) PCT Filed: Sep. 14, 2004
(86) PCT No.: PCT/EP04/52165

§ 371 Date: Feb. 23, 2007

(30) Foreign Application Priority Data
Nov. 21, 2003 (GB) 0327180.6

(51) Int. Cl. H04L 12/58

(52) U.S. Cl. 455/412.1; 455/418

(57) ABSTRACT

A wireless communication unit for use in a digital radio communication system comprising means for signal transmission, means for signal reception, a vocoder, a digital-to-analog converter and a microprocessor. The wireless communication unit further comprises a means for storing messages. The microprocessor, when activated, is adapted to stop playing a message while still recording said message in said means for storing messages and to start replaying said message stored in said means for storing messages from a beginning of said message.

### FIELD OF THE INVENTION

The present invention relates to digital communication systems, in general, and to digital wireless communication units, in particular.

### BACKGROUND OF THE INVENTION

Wireless communication units in digital communication systems are used by different types of public services like police, fire brigades, medical emergency, etc. Most of these services rely on accurate and timely information. Delays in receiving and understanding of messages may lead to catastrophic consequences.

On the other hand these services quite often operate in very hostile environment. This hostile environment may in different situations cause the message not to be correctly understood. One of such situation can be listening with shared attention while driving with high speed in a heavy urban traffic, which occurs very often in case of fire, police action or when emergency is called. Other situation when reception of a message by a human person may be heavily affected by surrounding is listening to the message in the presence of loud background noise, e.g. when truck passes by. There are many other situations when verbal information played by an audio output of the wireless communication unit is strongly affected by the environmental conditions.

As the information is important and can save people's life the message must be somehow repeated for the user of the radio.

In solutions known in the art the user can request the repetition of the message when its transmission is over. However this will cause some delay as the originator of the message (e.g. dispatch) must complete the message before its repetition.

In U.S. patent application US20030078083 A1 a wireless communication unit is presented which allows for storing received messages in a memory and their later replaying.

According to the US patent application the received message is stored in a digital format in a memory and can be replayed when the message transmission is completed.

Both these solutions have some drawbacks and the most important is that the listener must wait until the end of the transmission. This may lead to significant delays especially when the reception of the message was disturbed at the beginning of the transmission. This means that couple of vital seconds will be lost. Similarly by asking a dispatcher to repeat the message makes that couple of seconds are lost.

### SUMMARY OF THE INVENTION

There is a need for a wireless communication unit for use in a digital radio communication system and for a method of replaying a message in a wireless communication unit, which alleviate or overcome the disadvantages of the prior art.

According to a first aspect of the present invention there is thus provided a wireless communication unit for use in a digital radio communication system as claimed in claim 1.

According to a second aspect of the present invention there is thus provided a method of replaying a message in a wireless communication unit as claimed in claim 11.

Further aspects of the present invention are provided in the dependent claims.

The present invention beneficially allows for:
reducing a number of requests for repetition of the messages, which in turn reduces a network traffic;
reducing response time of emergency services;
relieving the dispatcher from repeating messages.

### BRIEF DESCRIPTION OF THE DRAWINGS

The present invention will be understood and appreciated more fully from the following detailed description taken in conjunction with the drawings in which:

FIG. 1 is a block diagram illustration of a wireless communication unit in accordance with a first embodiment of the present invention,

FIG. 2 is a block diagram illustration of a wireless communication unit in accordance with a second embodiment of the present invention,

FIG. 3 is a block diagram illustration of a wireless communication unit in accordance with a third embodiment of the present invention,

FIG. 4 is a block diagram illustration of a wireless communication unit in accordance with a fourth embodiment of the present invention,

FIG. 5 is a diagram illustrating a method of replaying a message in a wireless communication unit in one embodiment of the present invention.

### DETAILED DESCRIPTION OF AN EMBODIMENT OF THE INVENTION

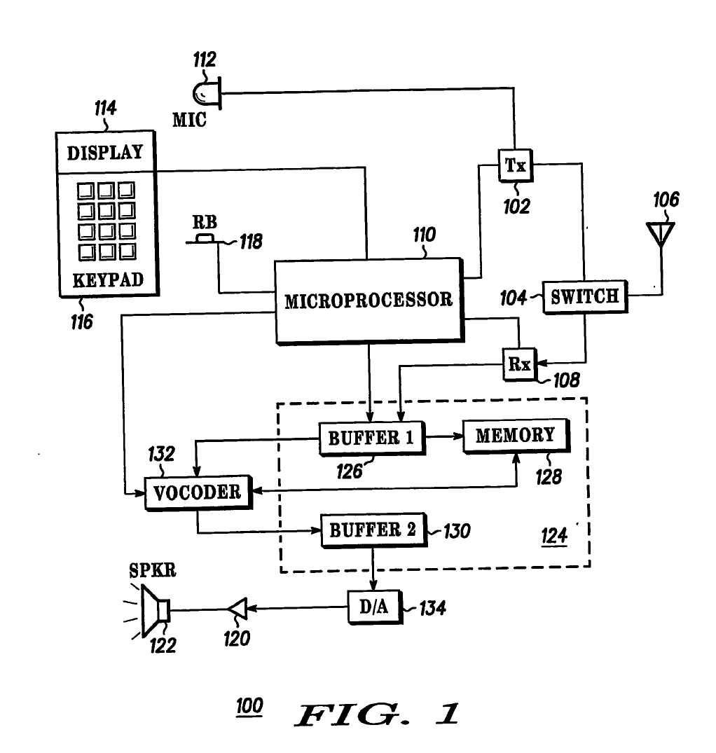

Referring to FIG. 1 one embodiment of a wireless communication unit in accordance with the present invention is presented.

The wireless communication unit of FIG. 1 may be either a portable or a mobile digital radio. The wireless communication unit 100 comprises a microphone 112 which provides a signal for transmission by transmission circuit 102. Transmission circuit 102 transmits via Radio Frequency (RF) switch 104 and antenna 106. The wireless communication unit 100 also has a microprocessor 110 and a keypad 114 and a display 116. Voice activation of the radio, or other means of interaction with a user, may also be implemented. Signals received by the radio are routed by the RF switch 104 to a receiving circuit 108. The received signals are routed from the receiving circuit 108 to microprocessor 110 and through means for storing messages 124 and a vocoder 132 and a digital-to-analog (D/A) converter 134 to an audio processing circuitry 120 and 122. A dedicated replay switch 118 is also connected to said microprocessor 110. Said means for storing messages 124 comprises a first buffer 126 for storing compressed speech data and a second buffer 130 for storing decompressed speech data as well as a memory 128 for storing recorded messages.

In operation a message is received by the antenna 106 and via the RF switch 104 is directed to the receiving circuit 108. When the reception of the message commences, received compressed speech data blocks are placed in the first buffer 126 from where, after a first predefined delay, they are taken for decompression in the vocoder 132. The decompressed speech data are placed in the second buffer 130 from where, after a second predefined delay, they are taken for construction of an analogue speech signal in the D/A converter 134. The predefined delays are to ensure that no gaps are introduced in the reproduced speech. The compressed speech data blocks from the first buffer are also copied to the memory 128 where the whole message is recorded. A block of compressed speech data or a decompressed speech data item is never processed twice, except for the case of mitigating the effect of a missing data block.

When the replay switch 118 is activated the microprocessor 110 closes the transfer of compressed speech data from the first buffer 126 to the vocoder 132 while maintaining transfer of said compressed speech data from the first buffer 126 to the memory 128. Simultaneously the microprocessor 110 instructs the vocoder 132 to start immediately processing the compressed speech data of the message stored in the memory 128. Following the instruction, the vocoder 132, starts processing the compressed speech data taken from said memory 128 starting from the message beginning stored therein. After decompression the speech data are transferred to the second buffer 130 and later to the D/A converter 134. The D/A converter's output is forwarded to the audio processing circuitry 120 and 122 and the message is replayed in the speaker 122 while the remaining portion of the message still being received by the receiving circuit 108 and recorded in the memory 128.

In one embodiment the message received by the wireless communication unit is a simplex message.

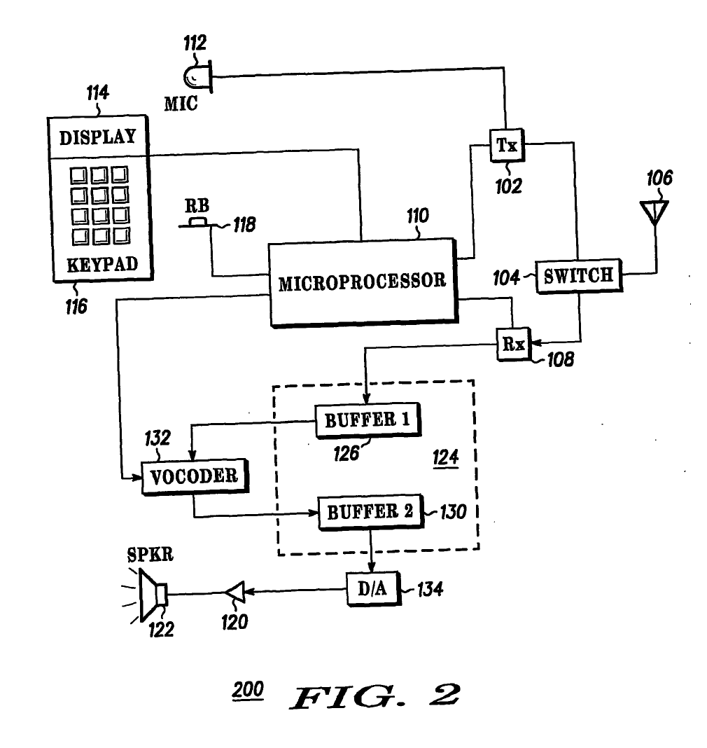

Referring to FIG. 2 a second embodiment of a wireless communication unit in accordance with the present invention is shown.

In this embodiment the means for storing messages 124 contains only the first buffer 126 and the second buffer 130.

In operation a message is received by the antenna 106 and via the RF switch 104 is directed to the receiving circuit 108. When the reception of a message commences, received compressed speech data blocks are placed in the first buffer 126 from where, after a first predefined delay, they are taken for decompression in the vocoder 132. The decompressed speech data are then placed in the second buffer 130 from where, after a second predefined delay, they are taken for construction of an analogue speech signal in the D/A converter 134. The predefined delays are to ensure that no gaps are introduced in the reproduced speech. The compressed speech data blocks are stored in the first buffer 126. A block of compressed speech data or a decompressed speech data item is never processed twice, except for the case of mitigating the effect of a missing data block.

When the replay switch 118 is activated the microprocessor 110 instructs the vocoder 132 to stop processing the message and to start immediately processing the compressed speech data of the message stored in the first buffer 126 starting from the message beginning. Following the instruction, the vocoder 132, starts processing the compressed speech data taken from said first buffer 126. After decompression the speech data are transferred to the second buffer 130 and later to the D/A converter 134. The D/A converter's output is forwarded to the audio processing circuitry 120 and 122 and the message is replayed in the speaker 122 while the remaining portion of the message still being received by the receiving circuit 108 and recorded in the first buffer 126. As in this embodiment the message is recorded in the first buffer 126 the size of the first buffer 126 must be large enough to store few minutes of voice.

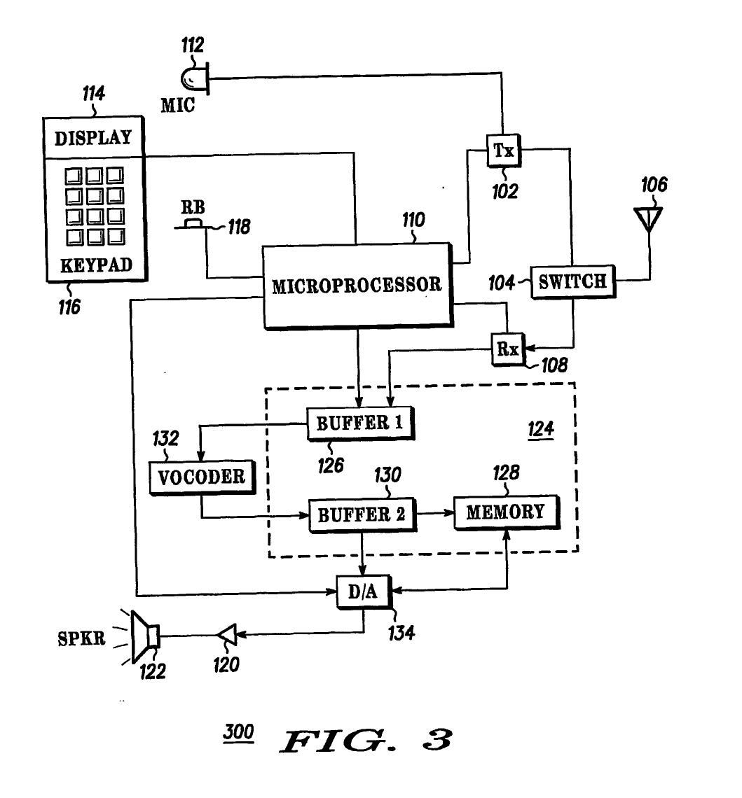

Referring to FIG. 3 a third embodiment of a wireless communication unit in accordance with the present invention is shown. The means for storing messages 124 contains the first buffer 126, the memory 128 and the second buffer 130. The memory 128 is connected to the second buffer 130 and to the D/A converter 134.

In operation the process of playing the message is performed in the same way as in the first embodiment however decompressed speech data blocks from the second buffer 130 are copied to the memory 128, where the whole message is recorded.

When the replay switch 118 is activated the microprocessor 110 closes the transfer of the decompressed speech data from the second buffer 130 to the D/A converter while maintaining transfer of said decompressed speech data from the second buffer 130 to the memory 128. Simultaneously the microprocessor 110 instructs the D/A converter 134 to start immediately processing the decompressed speech data of the message stored in the memory 128. Following the instruction, the D/A converter 134, starts processing the decompressed speech data taken from said memory 128 starting from the beginning the message stored therein. The D/A converter's output is forwarded to the audio processing circuitry 120 and 122 and the message is replayed in the speaker 122 while the remaining portion of the message still being received by the receiving circuit 108 and recorded in the memory 128.

Referring to FIG. 4 a fourth embodiment of a wireless communication unit in accordance with the present invention is shown.

In this embodiment the means for storing messages 124 contains only the first buffer 126 and the second buffer 130.

In operation the process of playing the message is performed in the same way as in the second embodiment, however the decompressed speech data blocks are stored in the second buffer 130.

When the replay switch 118 is activated the microprocessor 110 instructs the D/A converter 134 to stop processing the message and to start immediately processing the decompressed speech data of the message stored in the second buffer 130 starting from the message beginning. Following the instruction, the D/A converter 134, starts processing the decompressed speech data taken from the second buffer 130. The D/A converter's output is forwarded to the audio processing circuitry 120 and 122 and the message is replayed in the speaker 122 while the remaining portion of the message still being received by the receiving circuit 108 and recorded in the second buffer 130. As in this embodiment the message is recorded in the second buffer 130 the size of the second buffer 130 must be large enough to store few minutes of voice.

In one embodiment the microprocessor 110 of the wireless communication unit 100, 200, 300, 400 is adapted to initiate a transmission of a notification that the replay function is activated. This indicates that reply from this wireless communication unit will be delayed. It is important for the emergency services when procedures must be observed. Without such notification the dispatcher in e.g. police dispatch center would not be aware why the other party is not responding. For simplex calls the notification can be transmitted after the receiving the message is completed.

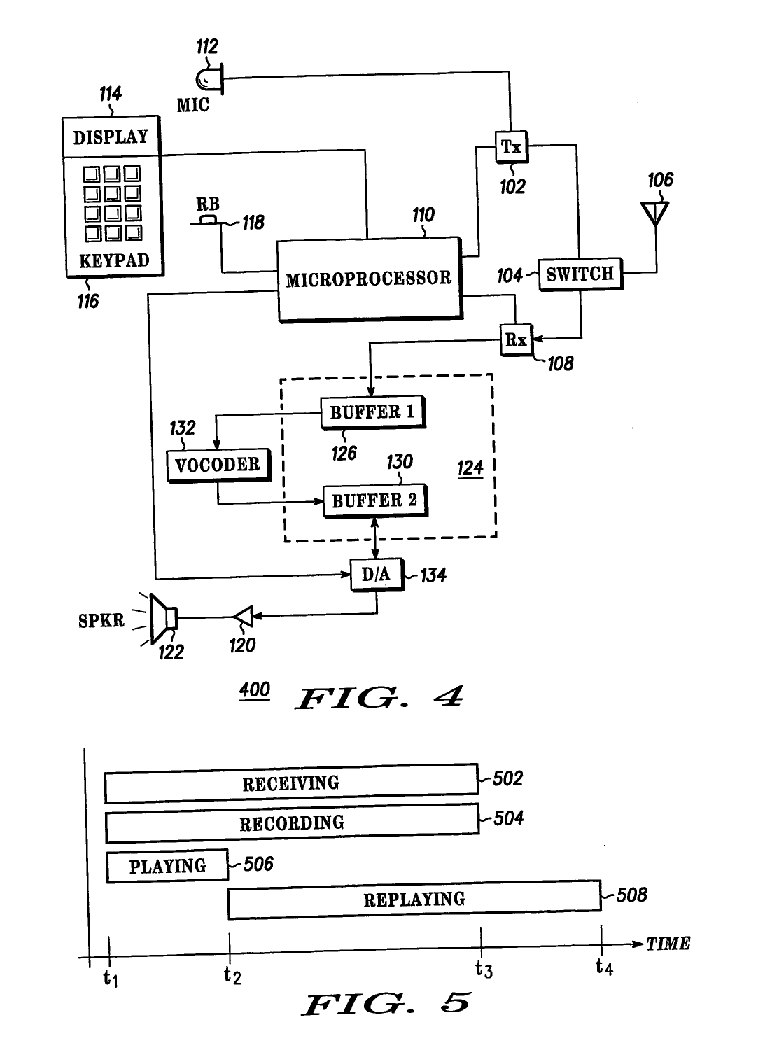

Referring to FIG. 5 one embodiment of a method of replaying a message in a wireless communication unit in accordance with the present invention is shown. The wireless communication unit starts receiving 502 the message at a time marked as t₁. At the time t₁ recording 504, in the means for storing messages 124, and playing 506 of the message, by the audio processing circuitry 120, 122, also starts. The processes of receiving 502 and recording 504 continues until the end of transmission of the message at a time marked as t₃. If a user of the wireless communication unit stops playing 506 the message at a time t₂ the microprocessor 110 controlling the wireless communication unit initiates replaying of the message from the recorded 504 data. It is important to note that this user's action does not stop receiving 502 and recording 504 of the message. The replaying 508 starts at the time t₂ and lasts until a time t₄. This causes the total delay of delivering the message to the user of the wireless communication unit is only t₂−t₁. And this can be significantly shorter than for solutions known in the art. Assuming that the message lasts 15 seconds and was interrupted after 3^{rd} second the total delay in delivering the message will be 3 seconds only and not 15, which is very important for emergency services. For those skilled in the art it is clear that there will be a small delay between terminating of playing the message and replaying the message from the means for storing messages 124. The delay is caused by a response time of electronic circuits and in particular by an access time to the means for storing messages 124. However modern memory modules are very fast and offer very short access time measured in a range of milliseconds, thus for the sake of clarity this small delay was not depicted on FIG. 5. Respectively the processing time of vocoder for decompression of the first block of stored compressed speech is in an order of few milliseconds. These two components of a delay are insignificant comparing to the message duration.

1. A wireless communication unit for use in a digital radio communication system, said wireless communication unit comprising:
means for signal transmission,
means for signal reception,
a vocoder,
a digital-to-analog converter,
a) microprocessor comprising means for storing messages b), when activated, means to stop playing a currently received message while still recording said message in said means for storing messages and c) means to start replaying said message stored in said means for storing messages from a beginning of said message.

2. The wireless communication unit according to claim 1, wherein said means for storing messages comprises a first buffer and a second buffer.

3. The wireless communication unit according to claim 2, wherein a memory connected to said first buffer and to said vocoder.

4. The wireless communication unit according to claim 2, wherein a memory is connected to said second buffer and to said digital-to-analog converter.

5. The wireless communication unit according to claim 2, wherein said vocoder upon reception of a signal from said microprocessor is adapted to stop playing said message from said first buffer and to start replaying said message from the beginning of said message, from said first buffer.

6. The wireless communication unit according to claim 2, wherein said digital-to-analog converter upon reception of a signal from said microprocessor is adapted to stop playing said message from said second buffer and to start replaying said message from the beginning of said message, from said second buffer.

7. The wireless communication unit, according to claim 3, wherein said vocoder upon reception of a signal from said microprocessor is adapted to stop playing said message from said first buffer and to start replaying said message from the beginning of said message, from said memory.

8. The wireless communication unit according to claim 4, wherein said digital-to-analog converter upon reception of a signal from said microprocessor is adapted to stop playing said message from said second buffer and to start replaying said message from the beginning of said message, from said memory.

9. The wireless communication unit according to claim 1, wherein said microprocessor is adapted to initiate a transmission of a notification that the replay is activated.

10. The wireless communication unit according to claim 1 further comprising a dedicated replay switch operably connected to the microprocessor.

11. A method of replaying a message received in a wireless communication unit comprising the steps of:
a) recording said message while playing said message in a speaker;
b) terminating said playing of said message and continuing on receiving and recording of said message,
c) replaying said recorded message from a beginning of said message, while continuing with receiving and recording said message.

12. The method according to claim 11, wherein said step of replaying starts after said step of terminating with a delay caused by a response time of an electronic circuitry or processing time of a vocoder.

13. The method according to claim 11, wherein said message is a simplex message.

14. The method according to claim 11, wherein said step of termination is initiated by a user of said wireless communication unit.

15. The method according to claim 11, wherein said message, when terminated, is still recorded in a first buffer.

16. The method according to claim 15, wherein said message is transferred from said first buffer to a memory.

17. The method according to claim 11, wherein said message, when terminated, is still recorded in a second buffer.

18. The method according to claim 17, wherein said message is transferred from said second buffer to a memory.

19. The method according to claim 15, wherein said message is retrieved by a vocoder from said first buffer.

20. The method according to claim 17, wherein said message is retrieved by a digital-to-analog converter from said second buffer.

21. The method according to claim 16, wherein said message is retrieved by a vocoder from said memory.

22. The method according to claim 18, wherein said message is retrieved by a digital-to-analog converter from said memory.

23. The method according to claim 11, wherein when said message is completely received a notification on activation of the replay is transmitted to a sender of said message.

24. The method according to claim 11, wherein any new incoming call is signalized when the replay is active.

25. (canceled)

26. The wireless communication unit according to claim 1, wherein said wireless communication unit is a TETRA radio or an ASTRO/APCO 25 radio or an IDEN radio.
